(19) United States
(12) Patent Application Publication
(10) Pub. No.: US 2008/0034008 A1
(43) Pub. Date: Feb. 7, 2008

(54) USER SIDE DATABASE

(75) Inventors: Eric Burke, Northville, MI (US); Alan Wada, Mountain View, CA (US); Brian Coe, Scotts Valley, CA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/462,242

(22) Filed: Aug. 3, 2006

(51) Int. Cl. G06F 17/30

(52) U.S. Cl. 707/201

(57) ABSTRACT

Internet applications provide personalized experiences, such as, a personalized greeting, by retrieving user information from a database maintained by a network content provider. A copy of at least some of the user information stored by the network content provider is saved on the user's computer by a user information manager for quick retrieval by one or more Internet applications. Synchronization between the provider database and the user database can be initiated in response to a request for user information received from a user side module, in response to the user information manager receiving new user information from another source and periodically by the user information manager.

### TECHNICAL FIELD

This disclosure is directed to computers and computer applications and, more particularly, to a method and system of storing information found on a content provider computer on a user computer.

### BACKGROUND

Various computer applications, such as, for example, Internet browsers, downloadable network toolbars, instant messaging (IM) applications, and the like, can include personalized information that enhances a user experience. For example, using personal information, such as, for example, a name, can allow a computer application to greet a user by their name. In addition, personal preferences, such as, for example, IM or email font settings, can be automatically loaded when a user opens a computer application. As known in the art, personal information can be stored by a network content provider on one or more Internet servers, so users can have access to their personalized experiences on any computer with a connection to the Internet.

Unfortunately, a connection to a network content provider may not always be available. For example, a user's Internet connection might be down and/or a network content provider might be temporality offline, for example, to perform maintenance to their servers. Additionally, some computers may have a slow connection to the Internet. Therefore, frequently accessing information from a network content provider may be an inefficient use of limited bandwidth, especially if different applications are downloading the same user information.

In addition, the same user can use a plurality of computer applications, therefore, a user may be required to reenter the same information into each of the different applications. Accordingly, there is a desire for methods and apparatus to over come these deficiencies and allow computer applications to obtain information in an efficient and reliable manner.

### SUMMARY

In one embodiment, a user information manager manages one or more user databases that are stored locally on a network user's computer. The user databases store at least some of the information stored in a user database located with a network content provider. The user information manager can execute at least one routine, the routine comprising receiving a request, from a user side module, for user information; synchronizing the requested user information stored in the local user database with the requested user information stored in the provider user database, retrieving the requested user information from the local user database; and transmitting the requested user information to the user side module.

In one embodiment, the user information manager determines whether a connection to the network content provider is available before synchronizing the requested user information stored in a local user database with the requested user information stored in a provider user database.

In one embodiment, the user information manager synchronizes the requested user information stored in a local user database with the requested user information stored in a provider user database by determining whether the requested user information stored on the provider user database is more desirable to a user. In response to desirable information on the provider user database, the user information manager updates the local user database with desirable user information; and in response to desirable information on the local user database, the user information manager updates the provider user database with desirable user information.

In one embodiment, the user information stored in the local user database is stored using a similar storage architecture as on the provider user database. In one embodiment, user information is identified using a key, and the key can be used to access the user information in a database. In one embodiment, the local user database comprises information for a default user. In one embodiment, the local user database encrypts its stored information. In one embodiment, the local user database is part of the user information manager, and in one embodiment, the user information manager is part of a user side module.

In one embodiment, the user information manager synchronizes the requested user information stored in a local user database with the requested user information stored in a provider user database by transmitting a message to the network content provider and receiving a reply from the network content provider comprising instructions for synchronizing the user information. The message comprises a network user identifier, a user information identifier, a time stamp, and a hash value generated from the user information stored at the local database.

In one embodiment, the user information manager can act as an invisible proxy between a user side module and a network content provider. Thus requests for user information can be intercepted by the user information manager, and requested user information returned to the user side module can be disguised to appear as if it was transmitted by the network content provider.

In one embodiment, a user information manager can receive user information; update a local user database, synchronize the received user information with user information stored in the local user database and with user information stored at a provider user database, and transmit the received user information to active user side modules that use the received user information. In one embodiment, the received user information is received from a user side module. In one embodiment, the received user information is received from a network user. In one embodiment, the received user information is received from a network content provider.

In one embodiment, the step of synchronizing the received user information with user information stored in the local user database and with user information stored at the provider user database is suspended until a connection to a network content provider is available.

In one embodiment, the a user information manager can request for user information from a network content provider, synchronize the requested user information stored in a provider user database with the requested user information stored in a local user database, and transmit the received user information to active user side modules that use the received user information. In one embodiment, the request can be periodic, and in one embodiment, the number of requests can be adjusted to a network connection speed.

In one embodiment, the user information manager receives a reply from the network content provider. In one embodiment, the reply indicates that the user information at the network content provider is same, and the user information in the local user database and the provider user database is synchronized. In one embodiment, the reply comprises new user information, and the received user information is saved in the local database. In one embodiment, the reply comprises a request for user information, and the requested user information is transmitted to the network content provider.

In one embodiment, a network content provider server can have a user information manager. The provider user information manager can be accessed by at least one provider side module, and can be defined by computer code being operable to execute at least one routine comprising, receiving a request, from a network user, for user information; synchronizing the requested user information stored on a provider user database with the requested user information stored on a database local to the network user, retrieving the requested user information from the provider user database, and transmitting the requested user information to the network user.

In one embodiment, a network content provider server can determine whether the requested user information stored on the provider user database is more desirable to a user. In response to desirable information on the provider user database, the database local to a network user is updated with desirable user information, and in response to desirable information on the local user database, the provider user database is updated with desirable user information.

In one embodiment, the network content provider synchronizes the requested user information stored on a provider user database with the requested user information stored on a database local to the network user by receiving a message from a network user. The message comprises a network user identifier, a user information identifier, a time stamp and a hash value generated from the user information stored at the local database. The network content provider continues by identifying user information stored at the provider user database using the network user identifier and the user information identifier, generating a hash value from the user information stored at the provider user database; comparing the received hash value with the provider generated hash value and transmitting a reply to the network user comprising instructions on synchronizing the user information.

In one embodiment, if the received hash value and the provider generated hash value are the same, the reply comprises a message indicating the user information at the database local to a network user and the provider user database are synchronized. In one embodiment, if the received hash value and the provider generated hash value are the different, the received time stamp and a time stamp associated with the user information stored at the provider user database are compared. In one embodiment, if the received time stamp is more current than the time stamp associated with the user information stored at the provider user database, the reply comprises a request for user information stored at the local user database. In one embodiment, if the time stamp associated with the user information stored at the provider user database is more current than the received time stamp, the reply comprises the user information associated with the time stamp.

In one embodiment, the provider user database is part of the network content provider user information manager. In one embodiment, the network content provider user information manager is part of a provider side module.

In one embodiment, a network content provider user information manager can execute at least one routine comprising receiving user information from a node in a network and synchronizing the received user information with user information stored on a provider user database and with user information stored on a database local to the network user. In one embodiment, the received user information is received from a user information manager. In one embodiment, the received user information is received from a second network content provider.

Other objects and features will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates a system implemented according to an embodiment.

FIG. 2 illustrates a user information request method, executed by a user side module, implemented according to an embodiment.

FIG. 3 illustrates a user information management method, executed by a user information manager, implemented according to an embodiment.

FIG. 4 illustrates a user information request method, executed by a user information manager, implemented according to an embodiment.

FIG. 5 illustrates a provider side user information management method, executed by a network content provider, implemented according to an embodiment.

### DETAILED DESCRIPTION OF EXEMPLARY EMBODIMENTS

There will now be shown and described in connection with the attached drawing figures several embodiments of a user side database and methods for providing the same.

The term Internet as used herein, unless otherwise specified expressly or by context, is intended to have a broad non-limiting definition, and refers, without limitation, to a computer network and any other group of computers communicatively coupled together.

Internet content providers can provide an Internet user with a suite of services comprising email, directions, instant messaging (IM) and other services. These services can be provided through an Internet browser, a plug-in to an Internet browser, a computer application, and any other module executable to perform instructions on a computer.

In order to personalize a user's experience with an offered service, in one embodiment, an Internet content provider can maintain an account with a user, and store the user's information in a server accessible through the Internet. User information can comprise, a name, an address, a username, a password, application settings, and other information. In one embodiment, user information can be organized using keys to identify the information. For example, a username is assigned key “00001” and a password is assigned key “00002.”

One example of a personalized user experience is greeting a user by name and including local traffic and weather reports, when the user opens an Internet browser. In addition, if the browser has a downloadable network toolbar installed, the network toolbar can load a set of buttons that were previously selected by a user into the toolbar, so the user has access to the buttons that are important to them. As is known in the art, this personalized information can be retrieved from an Internet content provider server over the Internet.

Unfortunately, if the browser or the toolbar cannot communicate with the Internet content provider, the user's information is not accessible, and the applications provide a more generic experience and/or become inoperable. In addition, even when a connection to the Internet content provider is available, the browser and the toolbar might separately ask an Internet content provider for the same information. This is a waste of resources, especially if a user's connection to the Internet is slow.

Therefore, in one embodiment, computer applications access user information from a user information manager running on the user's computer instead of the Internet content provider. The user information manger retrieves information from an Internet content provider and stores a copy of the retrieved information on the user's computer. In one embodiment, the information is stored at the user's computer in the same format as on the server.

Since the user information manager stores a copy of some or all of the user's information at the user's computer, if a connection to the Internet content provider is not available, the computer application can still load the last information retrieved from the Internet content provider and/or any information added by a user while the Internet connection was unavailable. The updated information can be sent to an Internet content provider server when a connection becomes available.

Additionally, since some of the user's personal information, such as, for example, the user's name, address and interests are the same, different computer applications can use the user information manager to obtain similar user information to reduce the number of communications and/or the size of communications between the computer and the Internet content provider.

A single computer can be shared by a number of users. Therefore, in one embodiment, the user information manger can maintain a plurality of user databases. In addition, in one embodiment, the user information manager encrypts the stored user information for security.

In one example, a user has a downloadable network toolbar installed as a plug-in to a browser on their computer. When the user runs the browser program, the downloadable toolbar application is initiated and requests button information for the user from a user information manager. The button information comprises toolbar settings and button characteristics. Button characteristics can include the title of the button, the type of the button, an icon associated with the button, menu items and other characteristics that define the button's look and function.

When the user information manager receives a request for user information, the user information manager attempts to contact the Internet content provider for the requested information. If communication with the Internet content provider is not available, the user information manager gives the downloadable toolbar, the user information stored in its local database. This stored information can be information obtained the last time a network connection was available. In addition the stored information can comprise, default information loaded by an application during installation and/or information updated by a user between connections to the network.

If communication with the Internet content provider is available, the user information manager checks the Internet content provider server for user information that is more desirable to a user. In one embodiment, the most current information is what is most desirable to a user.

In one embodiment, the user information manager sends the Internet content provider a user identifier, such as, for example, a username; a user information identifier, such as, for example a key; a time stamp; and a hash value generated from the user information. The Internet content provider server, retrieves the identified user information using the user name and key and generates a hash value from the user information stored on the server. If the hash values do not match, the server and/or the user information manager updates their databases. In one embodiment, the most current information is what is most desirable to a user, so the Internet content provider can compare time stamps to determine whether it should send the user information manager the user information stored at the server or if the Internet content provider should ask the user information manager for the information stored at the user computer.

In one embodiment, the user information manager can periodically check for more desirable information at an Internet content provider even though a computer application has not requested information. If more desirable information is obtained in a periodic check, the desirable information can be sent to any active applications. In one embodiment, a user information manger relies solely on a periodic check to retrieve desirable information, and the user information manager does not contact an Internet service provider when a computer application asks for user information.

In one embodiment, the computer applications do not know that a user information manager is running and sends requests for user information directly to an Internet content provider. The user information manager can intercept those information requests before they are transmitted to the network and provide the application with the information that it was requesting.

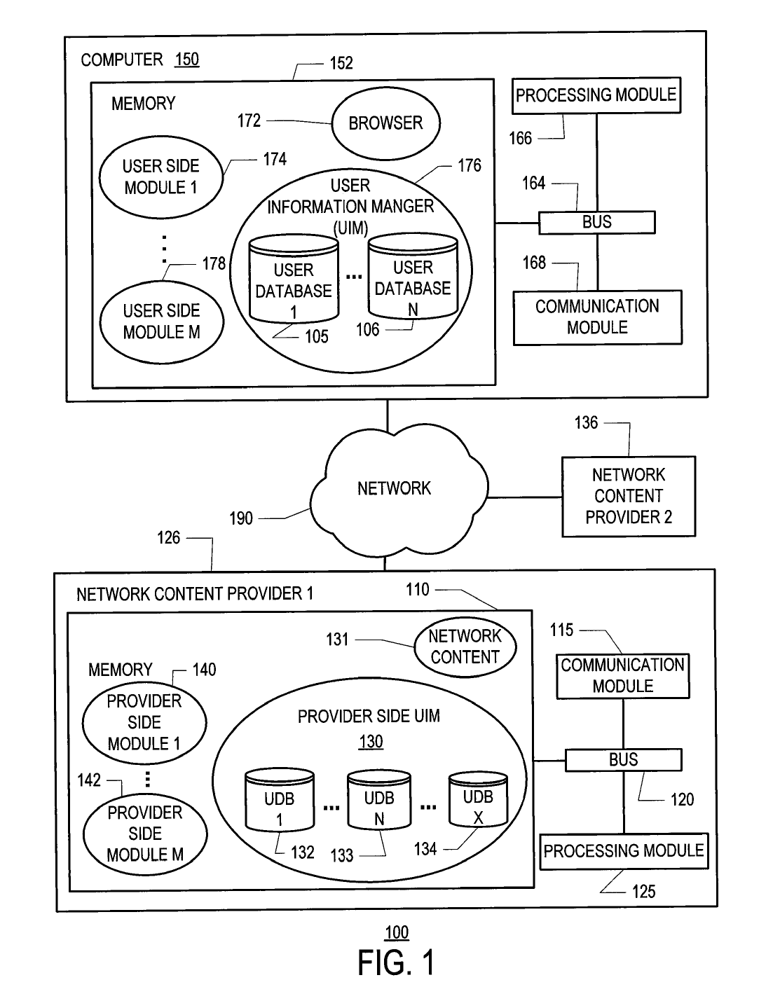

With reference to FIG. 1, there is shown a block diagram of a system 100 implemented in accordance with an embodiment. System 100 comprises a computer 150, a network content provider one 126, and a network content provider two 136, each coupled to a network 190, such as, for example, the Internet 190. Although illustrated as one symbol, nodes of network 190 may be coupled together by a combination of different networks. A network user can use computer 150 to access content and/or services from providers 126 and 136 through the network 190.

Computer 150 comprises a processing module 166, a communication module 168 and memory 152 coupled together by bus 164. The modules of computer 150 can be implemented as any combination of hardware, software, hardware emulating software and reprogrammable hardware. The bus 164 need not be a single bus, but rather, illustrates the interoperability of the different modules of the computer 150. In one embodiment, there may be multiple busses. In one embodiment, some modules are directly coupled instead of coupled via a bus 164. Computer 150 may be implemented as a desktop, a notebook computer, a Personal Digital Assistant (PDA), a handheld device, a wireless phone or any other device known or hereafter developed that is capable of performing functions as described herein.

In one embodiment, the processing module 166 can be implemented as, one or more Central Processing Units (CPUs), Field-Programmable Gate Arrays (FPGA), or any other component capable of executing computer applications. Communication module 168 comprises one or more I/O components used by the computer 150 to communicate with users and other devices. For example, components such as, a monitor, a keyboard, a mouse and a disk drive, can be used by a user to input and output information to and from the computer 150.

In addition, the communication module 168 facilitates two way communication between the computer and other electronic devices or systems, such as, for example, server computers provided by a network content provider one 126 and/or two 136. Components such as a modem, a network interface card (NIC), a wireless adapter, a Universal Serial Bus (BUS) adapter, etc., can be used by the computer 150 to communicate with the network 190, and/or with peripheral devices. The computer 150 may be communicatively connected to the network 190 through the communication module 168, for example, over one or more transmission media including but not limited to coaxial cable, copper wires and fiber optic cables. Communication between the computer 150 and the network 190 may also be accomplished via wirelessly.

In one embodiment, memory 152 provides electronic data storage using a combination of main memory (e.g., RAM) and drive storage. Any type of appropriate electronic memory can be used, including, without limitation, RAM, ROM, drive storage (hard, floppy, optical, etc.), non-volatile memory (e.g., flash) or any other memory that can store data. While memory 152 is illustrated with single box around it in FIG. 1, memory 152 can comprise one, two or more different types of modules of memory. In addition memory 152 can be part of other modules of computer 150, such as, for example, processing module 166.

In one embodiment as illustrated in FIG. 1, memory 152 has stored thereon a browser 172, user side modules “1” through “M” 174, 178 and a user information manager 176. A network user using computer 150 may gain access to the network 190, for example, the Internet 190, by using a browser 172. For example, a network user browsing the Internet 190 can use Universal Resource Identifiers (URIs), such as, for example, Universal Resource Locators (URLs), to locate and communicate with network content/service providers. In one embodiment, connection to the network 190 is provided through an Internet Service Provider (ISP).

In one embodiment, user side modules 147, 178 can be separate computer applications and/or plug-in applications, for example, a plug-in to the browser 172. One or more of the users side modules 147, 178 can request user information from user information manager 176, as described in the embodiments above and as will be further described below. Since a computer can have more than one user, user information manager 176 stores user database “1” 105 through user database N 106. In one embodiment, the user information stored by the user information manager 176 is encrypted to safely store the user's personal information on computer 150. In one embodiment, the user databases 105, 106 can be stored outside of the user information manager 176. In one embodiment, the user information manager 176 can be part of a user side module.

Network content provider 126 comprises communication module 115, processing module 125 and memory 110 coupled together by bus 120. Communication module 115, processing module 125, memory 110 and bus 120 can be implemented with components that are similar to the like named components of computer 150. The memory 110 of network content provider 126 has stored thereon, network content 131, provider side module “1” 140 through provider side module “M” and provider side user information manager 130.

In one embodiment, network content 131, can comprise webpages, that a user can download and view through a browser 172. The network content 131 can be personalized to a user by adding user information stored in either provider side user information manager 130 or user information manager 176.

Provider side user information manager 130, has stored thereon, user databases for network users that have accounts with the network content provider 126. Provider side user information manager 130 comprises user database “1” 132 through user database N 133 and from user database N 133 through user database X 134. In one embodiment, user database “1” 105 through user database N 106, which are stored on the computer 150, are exact copies of user database “1” 132 through user database N 133. In one embodiment, the user databases 105, 106 on the computer 150 comprises a portion of the information stored in the user databases 132, 133 on the network content provider computer 126.

Provider side modules 1 through M 140, 142 perform server side operations for the services used by a network user. For example, in an IM application the network content provider computer 126, through a provider side module 140, 142 can forward messages between IM users.

The user databases 132, 133, 134 and the provider side modules 140, 142 in network content provider computer 126 are depicted as stored in one location in FIG. 1, for illustrative purposes. For example, in one embodiment, user databases 132, 133, 134 can be separated in multiple computers. In one embodiment, information related to a network user can be separated in multiple computers. In one embodiment, each provider side module 140, 142 has a dedicated computer to operate its services. In one embodiment, user information in user databases 132, 133, 134 are stored with the provider side module 140, 142 that most frequently uses the information.

The location and number of the databases and modules in FIG. 1 illustrate one embodiment. In alternate embodiments, for example, for scalability, security or backup purposes the location and number of the databases and modules can be expanded and interchanged.

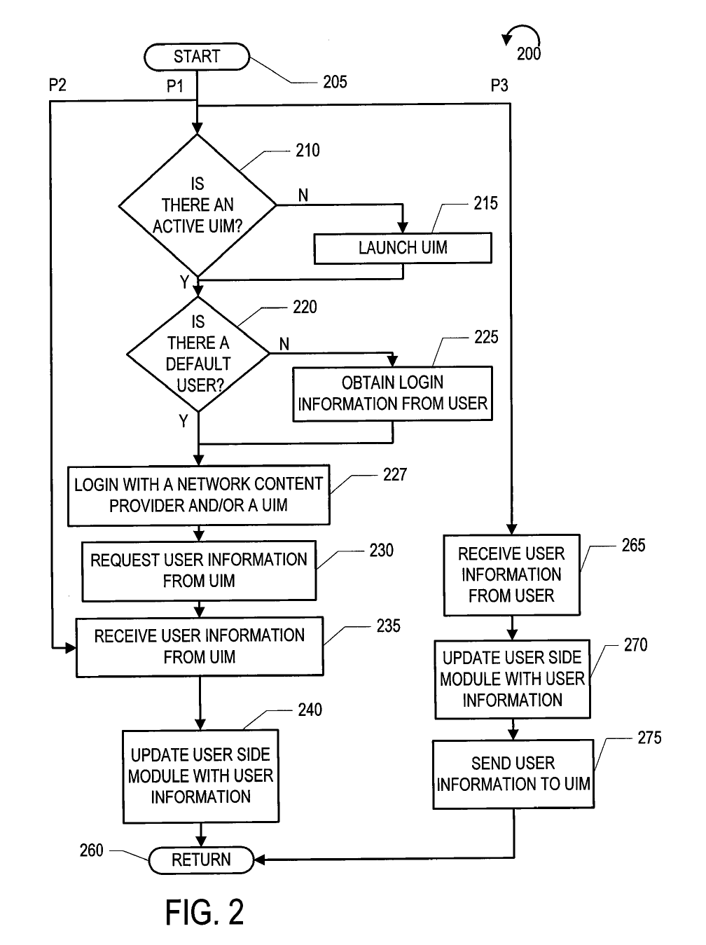

FIG. 2 illustrates an exemplary user information retrieval method 200 that may be executed, in one embodiment, by a user side module 174, 178 of computer 150. Method 200 starts in step 205. In one embodiment, when the user side module 174, 178 is executed by a user, method 200 proceeds down path P1 to step 210 where the user side module 174, 178 determines if there is an active user information manager 176. If there is no active user information manager 176, processing proceeds from step 210 to step 215 where the user side module 174, 178 launches a user information manager 176. Returning to step 210, if a user information manager 176 is active, processing proceeds directly to step 220. In one embodiment, a user information manager 176 is part of a user side module 174, 178 and launches automatically with the user side module 174, 178.

In step 220, the user side module 174, 178 determines if there is a default user. In one embodiment, the username and password of a default user is retrieved by the user information manager 176 from a cookie stored in the user's computer. In one embodiment, a default username and password is retrieved from the user information manager 176. In one embodiment, the default user can be a default setting which the user side module 174, 178 uses when no user is logged in with the network content provider 126. If there is a default user of the user side module 174, 178, method 200 proceeds from step 220 to step 227.

Returning to step 220, if there is no default user, processing proceeds from step 220 to step 225 where the user side module 174, 178 obtains login information from a user. In one embodiment, the user side module 174, 178 can provide the user with a webpage , a dialog, or any other input field that allows the user to enter a username and password corresponding to the user's account with a network content provider 126.

After obtaining user login information, method 200 proceeds to step 227, where the user side module 174, 178 logs into the user's account. In one embodiment, the user side module 174, 178 contacts the network content provider 126 and logs the user into the network content provider's 126 system. In one embodiment, the network content provider 126 logs into the network content provider's 126 system by logging-in with the user information manager 176. When a network connection is available, the user information manager 176 can contact the network content provider 126 and update the user's login status at the network content provider's 126 computer.

Following step 227 method 200 proceeds to step 230 where the user side module 174, 178 requests user information from the user information manager 176. The user information requested from the user information manager 176 can vary depending on the user side module 174, 178. For example, in one embodiment where the user side module 174, 178 is a downloadable network toolbar, user information can comprise, the toolbar settings and the button characteristics that are loaded in toolbar. Button characteristics can comprise the title of the button, an icon associated with the button, and computer instructions that define the operation initiated when a button is pressed. In one embodiment, where the user side module 174, 178 is an IM application, the user information can comprise personal settings, login preferences, IM environments, buddy lists and other user information.

In one embodiment, the user side module 174, 178 can operate without knowledge of the user information manager 176. For example, instead of asking the user information manager 176 for user information in step 230, in one embodiment, the user side module 174, 178 attempts to transmit a request for user information to a network content provider 126 in a manner known in the art. A user information manager 176 running on the user's computer 150 can intercept the request and retrieve the requested user information from its user database 105, 106. The user information manager 176 then composes a reply message, comprising the requested user information, which appears to come from a network content provider 126. The user side module 174, 178 receives the disguised message and loads the requested information for the user.

Following step 230, method 200 proceeds to step 235, where the user side module 174, 178 receives user information from the user information manager 176. Then, method 200 proceeds to step 240 where the retrieved user information is loaded in the user side module 174, 178, to provide user of the user side module 174, 178 with a personalized user experience. Following step 240, method 200 returns in step 260, for example, to start step 205. In one embodiment, when the user is finished with the user side module 174, 178, method 200 ends in step 260.

Returning to step 205, in one embodiment, a user side module 174, 178 can receive new information from the user information manager 176. New information can comprise, for example, an advertisement, new content for a toolbar button and other network content. Thus, from step 205 method 200 can proceed down path P2, to step 235 where the user side module 174, 178 receives user information from a user information manager 176. Then, in step 240, the user information manager 176, determines which active user side modules 174, 178 uses the new information so it can send the new user information to those user side modules 174, 178. Following step 240, method 200 returns, in step 260, for example to step 205.

Returning to step 205, in one embodiment, a user side module 174, 178 can receive new information from the user. For example, the new information can be an updated password, updated user preferences, and other information. Thus, method 200 can proceed down path P3 to step 265 where the user side module 174, 178 receives user information from the user. Following step 265, in step 270, the user side module 174, 178 updates itself with the received user information. For example, a downloadable network toolbar can update its buttons according to the information received from the user. In step 275 the user side module 174, 178 sends the received user information to user information manager 176, so the user information manager 176 can update its database. Then method 200 returns in step 260, for example, to step 205.

The order of steps 270 and 275, is not significant and can be reversed. In addition, the steps of all methods described herein, can be rearranged and/or omitted in alternate embodiments unless otherwise stated.

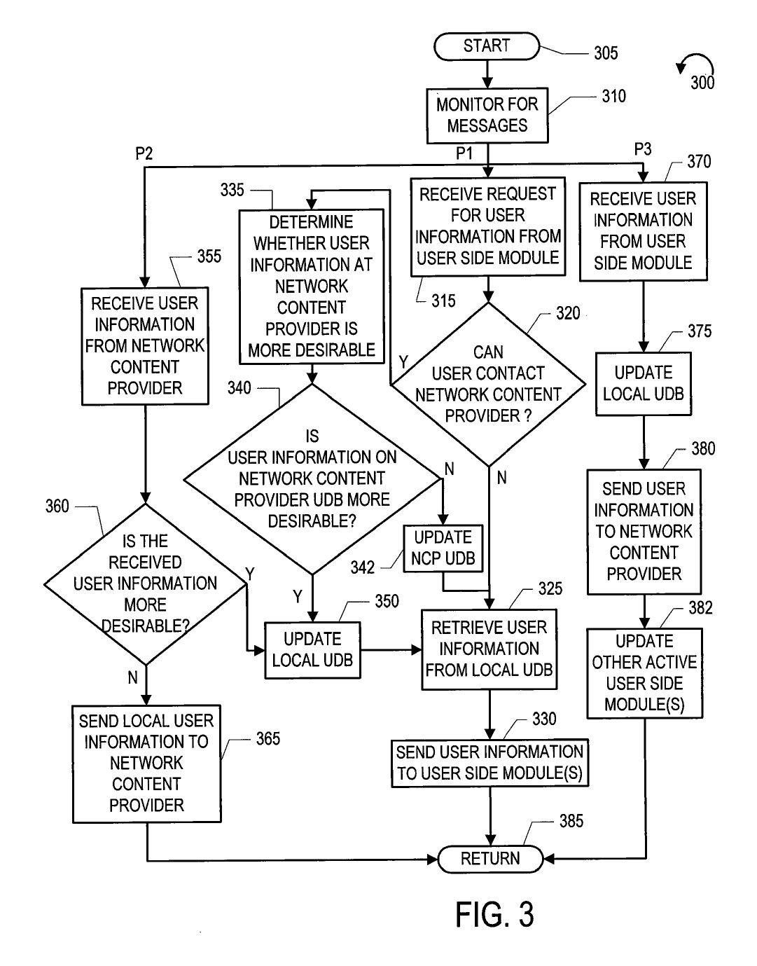

FIG. 3 illustrates an exemplary user information management method 300 which can be executed, in one embodiment, by the user information manager 176 of computer 150. Method 300 starts at step 305. In one embodiment the user information manager 176 can be initiated by a user side module 174, 178 running on computer 150. In one embodiment, the user information manager 176 can be initiated automatically with a user side module 174, 178. In one embodiment, the user information manager 176 is initiated when the computer 140 is started up, and in one embodiment, the user information manager 176 is initiated when a connection to the network 190 becomes available.

From step 305, method 300 proceeds to step 310 where the user information manager 176 monitors for messages from user side modules 174, 178, network content provider 126, the computer 150, the user and any other person, entity or module that interacts with the user information manager 176. Method 300 can proceed down a plurality of paths depending on the message received. For example, following path PI, method 300 proceeds from step 310 to step 315 where the user information manager 176 receives a request for user information from a user side module 174, 178.

Then, in step 320 the user information module 176 determines whether it can contact a network content provider 126. If the user information manager 176 cannot contact the network content provider 126, method 300 proceeds from step 320 to step 325.

Returning to step 320 if a connection to a network content provider is available processing proceeds from step 320 to step 335 where the user information manager 176 determines whether user information stored at the network content provider is more desirable to a network user or whether the information locally stored is more desirable. In one embodiment, the user information manager 176 can generate a hash value for the requested user information and send the hash value to a network content provider 126, along with a username, a key and a time stamp. The network content provider 126 generates a hash value from the user information stored on its database and compares the value to the received hash value. If there is a difference between the hash values, then more desirable information exists on either the network content provider's 126 database and/or the user information manager's 176 database.

In one embodiment, the most current information is most desirable for a user. In order to determine current information, the information stored on the databases comprise time stamps. By comparing time stamps the user information manager 176 and/or the network content provider 126 can determine what information is more desirable to a user.

Following step 335, in step 340, if user information on the network content provider's 126 user database is more desirable, method 300 proceeds to step 350, where the user information manager's 176 user database is updated. Following step 350, method 300 proceeds to step 325. Returning to step 340, if the user information on the network content provider's 126 user database is not more desirable, method 300 proceeds to step 342, where the network content provider's 126 user database is updated. Following step 342, method 300 proceeds to step 325.

Different user side modules 174, 178 on the same computer, or on different computers might try to update a network content provider 126 database for the same user at the same time. This could lead to updating errors and/or synchronization errors between user side modules 174, 178. Therefore, in one embodiment, when a first user side module attempts to update information on a network content provider 126 database, that piece of information is locked to other user side modules 174, 178. Thus, other user side modules 174, 178 trying to update information are asked to retry until the first user side module is finished.

Method 300 can proceed to step 325 from steps 320, 342 or 350. In step 325, the user information manager 176 retrieves user information from a local user database 105, 106 and in step 330 the user information manager 176 sends the retrieved user information to a requesting user side module 174, 178. Then, method 300 returns, in step 385, for example, to monitoring step 310.

Returning to step 310, the user information manager 176 can receive information from a network content provider 126. For example, the received information can comprise updated buttons for a toolbar, a new banner advertisement, user preferences updated from another computer, an RSS feed, and other information. Therefore, method 300 can proceed down path P2 to step 355 where the user information manager 176 receives user information from a network content provider 126.

Following step 355, method 300 proceeds to step 360 where the user information manager 176 determines if the received user information is more desirable to a network user. In one embodiment, the user information manager 176 compares a time stamp on the received information and compares it to a time stamp on similar information stored by the user information manager 176.

If the received information is more desirable, the user information manager 176 updates its database and sends the received information to active user side modules 174, 178 as described above in steps 350, 325 and 330. Returning to step 360, if the received information is not more desirable, then the user's account at the network content provider 126 does not comprise desirable information and should be updated. Thus, method 300 proceeds from step 360 to step 365 where the user information manager 176 sends the locally stored user information to a network content provider 126. Method 300 returns, in step 385, for example, to step 310.

Returning to step 310, when a user enters new information in a user side module 174, 178, such as, for example, updating their preferences, these changes are updated in the user information manager's 176 database. Thus, method 300 can follow path P3 to step 370 where the user information manager 176 receives user information from a user side module 174, 178. Following step 370 method 300 proceeds to step 375 where the user information manager 176 updates its database. Then, in step 380, the user information manager 176 sends the updated user information to the network content provider 126 in order to synchronize the user's information at the network content provider's 126 computer. A computer user can run more than one user side module 174, 178 at the same time. Therefore, following step 380, in step 382, other active user side modules 174, 178 are updated with the received user information. The method 300 returns in step 585, for example, to step 310.

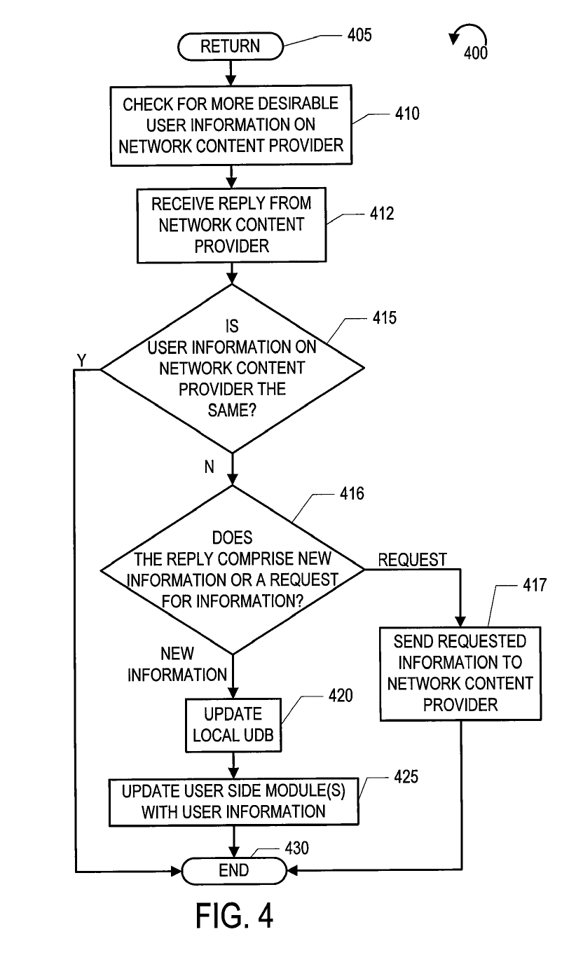

In one embodiment, a user information manager 176 can periodically and/or on command contact a network content provider 126 for updates and other additional information. FIG. 4 illustrates a user information request method 400, implemented in accordance with one embodiment, that can be executed by user information manager 176. Some user information such as RSS feeds and traffic information is volatile and can change frequently, while other user information, such as, for example a username and an address, do not change frequently. Thus, in one embodiment, the user information manager 176 can periodically check for new user information more frequently for certain keys or certain groups of keys and less frequently for other keys or groups of keys.

Method 400 starts in step 405 and proceeds to step 410. In step 410, the user information manager 176 checks for more desirable user information at the network content provider 126. In one embodiment, user information manager 176 generates one or more hash values using its stored user information and sends the hash values along with a username, a key or group of keys and associated time stamps to the network content provider 126. The network content provider 126 generates it own hash values and determines which information should be updated and at which database.

Following step 410, method 400 proceeds to step 412, where the user information manager 176 receives a reply from the network content provider 126. Following step 412, method 400 proceeds to step 415. In step 415, if the network content provider 126 has the same information as the user information manager 176, the reply, in one embodiment, can comprise a message informing the user information manager 176 that its locally stored user information is synchronized. Then, method 400 ends in step 430.

Returning to step 415, if the user information on the network content provider 126 is not the same, method 400 proceeds to step 416. If the network content provider 126 has more desirable information, in one embodiment, the network content provider 126 sends the more desirable information to the user information manager 176 in the reply sent in step 412. If the user information manager 176 has more desirable information, the network content provider 126 can request for that information in the reply sent in step 412.

Therefore, following step 415, in step 416, if a request for information is received by the user information manager 176, method 400 proceeds to step 417, where the user information manager 176 sends the requested information to the network content provider 126. Then method 400 ends in step 430.

Returning to step 416, if the user information manager 176 receives new information from the network content provider 126, method 400 proceeds to step 420 where the received information is updated in a local user database. Following step 420, method 400 proceeds to step 425, where the received information is updated in active user side modules 174, 178 running on the user's computer, if applicable. Then method 400 ends in step 430.

In one embodiment, if the user information manager 176 does not receive a reply from the network content provider 126, in step 412, the user information manager 176 can assume it has desirable information.

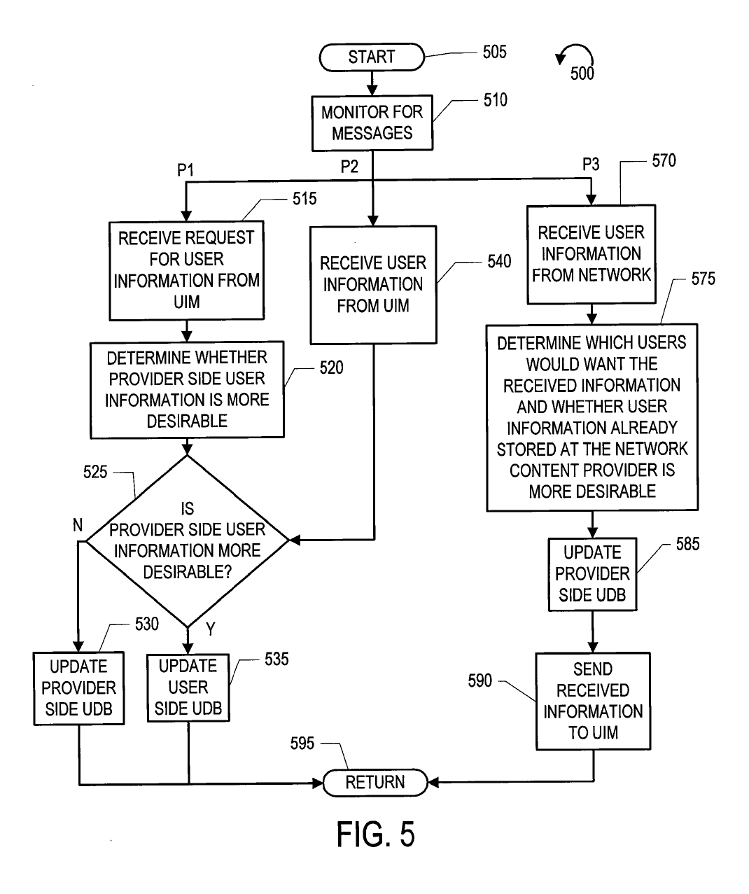

FIG. 5 illustrates a provider side user information management method 500, implemented in accordance with an embodiment. In one embodiment, method 500 can be executed by provider side user information manager 130 of FIG. 1. The method 500 starts in step 505. Then method 500 proceeds to step 510 where the network content provider computer 126 monitors for messages from network users, other content providers and other nodes on the network. The network content provider 126 can process a plurality of messages from a plurality of different nodes on the network.

Different user information managers across the network can contact the network content provider computer 126 for user information. Thus, method 500 can follow path P1 to step 515 where a request for user information is received. In one embodiment, the request can comprise, a user identifier, a key identifying the desired user information in the user database, a time stamp and a hash value generated from the user information stored at a user information manager 176.

Following step 515, method 500 proceeds to step 520 where the network content provider computer 126 determines whether the information stored at the network content provider 126 is more desirable than the user information stored at the user's computer. In one embodiment, the network content provider 126, can generate a hash value from the user information stored at the computer, and compare it to the received hash value. If the hash values are the same, in one embodiment, the network content provider 126 can send a message to the user information manager 176 informing the user information manager 176 that its user information is synchronized.

If the hash values are different, in one embodiment, the network content provider 126 can compare time stamps to determine which database should be updated. Therefore, in step 525, if a network content provider computer 126 determines the information at the provider is more desirable, method 500 proceeds to step 535 where the user information manager's 176 user database is updated. In one embodiment, the network content provider 126 can send the more desirable information to the user information manager 176 in a reply message.

Returning to step 525, if the network content provider computer 126 determines that the information at the provider is less desirable, then the network content provider computer 126, in step 530, updates the user database. In one embodiment, the network content provider 126 sends a request to the user information manager 176 for the desirable information. Method 500 returns in step 595, for example, to monitoring step 710.

A network content provider computer 126 can also receive user information from a user information manager 176, without request the information. Thus, from monitoring step 510, method 500 can proceed down path P2 to step 540 where user information is received. Following step 540, method 500 proceeds to step 525, and continues as describe above.

The network content provider 126 can also receive information from other nodes on the networks, such as, for example, network content provider 136. This information can include, for example, an RSS feed. Thus, returning to step 510, method 500 can proceed down path P3, to step 570 where network content provider 126 receives information from the network.

From step 570, method 500 proceeds to step 575 where the network content provider 126 identifies which users would want the new information and whether information already saved at the network content provider 126 is more desirable to a user. For example, if a network content provider 126 receives a new RSS feed, the network content provider 126 sends the new headlines to users who subscribe to the feed.

After a user is identified as desiring the received information, method 500, in step 585 updates its user database. Then, method 500 proceeds to step 590 where the network content provider 126 sends the received user information to one or more user information managers 176. Then method 500 returns, in step 595, for example, to step 510.

It will be recognized that while the features and functions described above are described in relation to network components and user side components, such features and functions can be implemented at any point in the network, on single or multiple computers and/or servers, and network functions can also be duplicated at the user computer for functioning independent of the network if desired. Thus user side changes and or network side changes can be synchronized and or synchronized when a user returns to the network in manners known in the art or hereafter to become known.

While the description of the various embodiments are described in a server/client network environment, alternate embodiments of the invention can be performed in a peer-to-peer network or other interconnectivity schemes now known or hereafter to become known.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A user information manager being loaded on a network user computer, the user information manager comprising:
message receiving computer code, the message receiving computer code configured to receive a request for user information from a user side module loaded on the network user computer;
synchronization computer code, the synchronization computer code configured to synchronize the requested user information stored in a local user database loaded on the network user computer with the requested user information stored in a provider user database managed by a network content provider, so that the user information is locally accessible to the network user computer, the local user database comprising at least some of the information stored in the provider user database;
information retrieval computer code, the information retrieval computer code configured to retrieve the requested user information from the local user database; and
information transmitting computer code, the information transmitting computer code configured to transmit the requested user information or a pointer to the requested user information to the user side module.

2. The user information manager of claim 1, further comprising network connection computer code, the network connection computer code configured to determine whether a connection to a network content provider is available.

3. The user information manager of claim 1, further comprising desirability computer code, the desirability computer code configured to determine whether the requested user information stored on the provider user database is more desirable to a user or whether the requested user information stored on the local user database is more desirable to a user.

4. The user information manager of claim 3, wherein most current user information is more desirable to a user.

5. The user information manager of claim 1, wherein the network user information is stored in the local user database using a similar storage architecture as on the provider user database.

6. The user information manager of claim 1, wherein user information is identified using a key, and wherein the key is used to access the user information in a database.

7. The user information manager of claim 1, wherein the synchronization computer code is configured to:
transmit a message to the network content provider, the message comprising,
a network user identifier;
a user information identifier;
a time stamp, and
a hash value generated from the user information stored at the local database; and
receive a reply from the network content provider comprising instructions for synchronizing the user information.

8. The user information manager of claim 1, further comprising:
message intercepting computer code, the message intercepting computer code configured to intercept a request for user information addressed to the network content provider; and
message disguising computer code, the message disguising computer code configured to disguise the requested user information to appear as if it was transmitted by the network content provider.

9. The user information manager of claim 1, wherein the local user database comprises information for a default user.

10. The user information manager of claim 1, wherein the information stored in the local user database is encrypted.

11. The user information manager of claim 1, wherein the local user database is part of the user information manager.

12. The user information manager of claim 1, wherein the user information manager is part of the user side module.

13. A user information manager being loaded on a network user computer, the user information manager comprising:
information receiving computer code, the information receiving computer code configured to receive user information from a user side module or from the Internet;
updating computer code, the updating computer code configured to update a local user database stored on the network user computer, the local user database configured to store at least some of the information stored in a provider user database maintained by a network content provider;
synchronization computer code, the synchronization computer code configured to synchronize the received user information with user information stored in the local user database and with user information stored at the provider user database, so that the user information is locally accessible to the network user computer; and
information transmitting computer code, the information transmitting computer code configured to transmit the received user information to active user side modules that use the received user information.

14. The user information manager of claim 13, further comprising network connection computer code, the network connection computer code configured to determine whether a connection to a network content provider is available.

15. The user information manager of claim 13, wherein the user information manager is configured to receive user information from a user side module.

16. The user information manager of claim 13, wherein the user information manager is configured to receive user information from a network user.

17. The user information manager of claim 13, wherein the user information manager is configured to receive user information from a network content provider.

18. A user information manager being loaded on a network user computer, the user information manager comprising:
information requesting computer code, the information requesting computer code configured to request user information from a network content provider, the network content provider maintaining a provider user database;
synchronization computer code, the synchronization computer code configured to synchronize the requested user information stored in the provider user database with the requested user information stored in a local user database loaded on the network user computer, so that the user information is locally accessible to the network user computer, and wherein the local user database stores at least some of the information stored in the provider user database; and
information transmitting computer code, the information transmitting computer code configured to transmit received requested user information to active user side modules that use the received requested user information.

19. The user information manager of claim 18, further comprising message receiving computer code, the message receiving computer code configured to receive a reply from the network content provider.

20. The user information manager of claim 19, wherein the reply indicates that the user information at the network content provider is same, and thus the user information in the local user database and the provider user database is synchronized.

21. The user information manager of claim 19, wherein the reply comprises new requested user information.

22. The user information manager of claim 19, wherein the reply comprises a request for user information stored in the local user database.

23. A method of managing user information on a network user computer via a user information manager loaded on the network user computer, the method comprising:
receiving a request for user information from a user side module loaded on the network user computer;
synchronizing the requested user information stored on a provider user database, the provider user database being maintained by a network content provider, with the requested user information stored on a local user database loaded on the network user computer, so that the user information is locally accessible to the network user computer, the local user database comprising at least some of the information stored in the provider user database;
retrieving the requested user information from the local user database; and
transmitting the requested user information to the user side module.

24. The method of claim 23, further comprising:
determining whether a connection to the network content provider is available; and
performing the step of synchronizing the requested user information stored on a provider user database with the requested user information stored on the local user database in response to an available connection.

25. The method of claim 23, wherein the step of synchronizing the requested user information stored on a provider user database with the requested user information stored on the local user database comprises:
determining whether the requested user information stored on the provider user database is more desirable to a user;
in response to desirable information on the provider user database, updating the local user database with desirable user information; and
in response to desirable information on the local user database, updating the provider user database with desirable user information.

26. The method of claim 23, further comprising using a key to access the user information in a database.

27. The method of claim 23, wherein the step of synchronizing the requested user information stored on a provider user database with the requested user information stored on a database local to the network user comprises:
receiving a message from a network user, the message comprising,
a network user identifier,
a user information identifier,
a time stamp, and
a hash value generated from the user information stored at the local database; and
identifying user information stored at the provider user database using the network user identifier and the user information identifier;
generating a hash value from the user information stored at the provider user database;
comparing the received hash value with the provider generated hash value; and
transmitting a reply to the network user comprising instructions on synchronizing the user information.

28. The method of claim 27, wherein the received hash value and the provider generated hash value are the same, and wherein the reply comprises a message indicating the user information at the database local to a network user and the provider user database are synchronized.

29. The method of claim 27, wherein the received hash value and the provider generated hash value are the different, and wherein the step of synchronizing the requested user information stored on a provider user database with the requested user information stored on a database local to the network user further comprises, comparing the received time stamp with a time stamp associated with the user information stored at the provider user database.

30. The method of claim 27, wherein the received time stamp is more current than the time stamp associated with the user information stored at the provider user database, and wherein the reply comprises a request for user information stored at the local user database.

31. The method of claim 27, wherein the time stamp associated with the user information stored at the provider user database is more current than the received time stamp, and wherein the reply comprises the user information associated with the time stamp.

32. A method of managing user information on a network user computer via a user information manager loaded on the network user computer, the method comprising:
receiving user information from a user side module loaded on the network user computer or from the Internet;
updating a local user database loaded on the network user computer, the local user database configured to store at least some of the information stored in a provider user database, the provider user database being maintained by a network content provider;
synchronizing the received user information with user information stored in the local user database and with user information stored at the provider user database, so that the user information is locally accessible to the network user computer; and
transmitting the received user information to active user side modules that use the received user information.

33. The method of claim 32, wherein the received user information is received from a user side module.

34. The method of claim 32, wherein the received user information is received from a network user.

35. The method of claim 32, wherein the received user information is received from a network content provider.

36. The method of claim 32, wherein the received user information is received from a second network content provider.

37. A method of managing user information on a network user computer via a user information manager, the method comprising:
requesting user information from a network content provider, the network content provider maintaining a provider user database;
synchronizing the requested user information stored in the provider user database with the requested user information stored in a local user database loaded on the network user computer, so that the user information is locally accessible to the network user computer, and wherein the local user database stores at least some of the information stored in the provider user database; and
transmitting received requested user information to active user side modules that use the received requested user information.

38. The method of claim 37, wherein said step of requesting user information from a network content provider is periodic.

39. The method of claim 38, wherein the step of requesting user information from a network content provider is adjusted to a network connection speed.
